(19) United States
(12) Patent Application Publication
(10) Pub. No.: US 2025/0379733 A1
(43) Pub. Date: Dec. 11, 2025

(54) CRYPTOGRAPHIC PSEUDONYM MAPPING METHOD, COMPUTER SYSTEM, COMPUTER PROGRAM AND COMPUTER-READABLE MEDIUM

(71) Applicant: Xtendr ZRT., Budapest (HU)

(72) Inventors: Attila Bágyoni-Szabó, Vác (HU); Ferenc Vágujhelyi, Budapest (HU)

(21) Appl. No.: 18/878,410

(22) PCT Filed: Jun. 22, 2023
(86) PCT No.: PCT/HU2023/050040

§ 371 Date: Dec. 23, 2024

(30) Foreign Application Priority Data
Jun. 23, 2022 (HU) P2200234

(51) Int. Cl. H04L 9/30; H04L 9/00

(52) U.S. Cl. CPC H04L 9/3013; H04L 9/008; H04L 9/3066; H04L 2209/08; H04L 2209/42

(57) ABSTRACT

The invention is a cryptographic pseudonym mapping method for an anonymous data sharing system, the method being adapted for generating pseudonymised data from entity data originating from data sources (DSᵢ), wherein the data are identified at the data sources (DSᵢ) by entity identifiers (D) of the respective entities, and wherein the pseudonymised data are identified by pseudonyms assigned to the respective entity identifiers (D) applying a one-to-one mapping. Furthermore, the invention is a computer system implementing the method, and a computer program and a computer-readable medium.

### TECHNICAL FIELD

The invention relates to a cryptographic pseudonym mapping method, a computer system, a computer program and a computer-readable medium.

### BACKGROUND ART

The document WO 2021/009528 A1 entitled “Cryptographic pseudonym mapping method, computer system, computer program and computer-readable medium” discloses a cryptographic method allowing many mutually independent entities—hereinafter: data sources—forming a decentralised system to unify the data sets or data streams in their possession by replacing the identifiers of the entities (e.g. persons, companies, geographical locations) stored therein with pseudonyms such that each entity receives a secret but unique identity (always the same pseudonym is generated from the same identifier, while from different identifiers always or almost always different pseudonyms are generated, independent of which data source is the originator of the data), i.e., data that originate from different data sources but correspond to the same entity can be connected together based on the pseudonyms. The method disclosed in the referenced document also provides that the anonymity provided by the pseudonyms is cryptographically secure even in case there is a malicious collusion between some of the entities adapted for mapping the pseudonyms—hereinafter: mappers—in order to crack anonymity. However, this known technical solution is not able to provide adequate protection in the case of a similar malicious collusion between a data source and a mapper.

The problem to be solved is characterised by the following:
1. Many mutually independent participants (hereinafter: data sources)
2. possess data records containing data related to entities (e.g., private individuals, companies),
3. said data records also containing data applicable for identifying the entities (hereinafter: entity identifiers, these can for example be identity card numbers),
4. said data records are to be submitted by the data sources to a (distributed or centralised) data collection system (e.g., for analysis),
5. and in which data records the data sources intend (e.g., due to the sensitive nature of the data) to replace the entity identifiers with artificial identification numbers (hereinafter: pseudonyms) before submitting the data for data collection,
6. of which pseudonyms it is required (e.g., because the analysis to be performed on the data requires it) that
   a. data corresponding to a given entity must be able to be connected together based on the pseudonyms,
   b. a given entity identifier must always be replaced by the same pseudonym, irrespective of which data source possesses the given data record,
   c. however, none of the data sources (or other participants) should be able to gather any extra information in addition to the information described in the preceding two points based on the pseudonyms (or the process generating them),
   d. with a special regard to ensuring that it is not possible to find out which entity identifier is replaced by a given pseudonym.
7. These measures are to be taken by the data sources in the most secure manner possible, paying special attention to the following:
   a. that neither the data sources nor any external entity needs to be assigned special roles or permissions, and
   b. that the requirements set for the pseudonyms are met even in case there is a malicious collusion between the data sources (the malicious collusion involving even the operator of the data collection system).

The prior art relevant to the industrial field includes a number of devices aimed at the solution of this complex problem, but these usually have serious shortcomings from the aspects of security or usability. According to one of the most frequently applied methods, the pseudonym is obtained from the entity identifier by a hash function.

Although this solution is able to prevent a trivial discovery of the relationship between the entity identifiers and the pseudonyms, it is of no use against targeted attacks aimed at cracking the anonymity of a particular entity, because any identifier can be mapped to the corresponding pseudonym by any one of data sources by itself.

Another problem that is similar to the above-mentioned one, and has relevance especially in academic circles, is the so-called “secure equality test” (see e.g., Geoffroy Couteau: New Protocols for Secure Equality Test and Comparison, Applied Cryptography and Network Security (pp. 303-320), ISSN 0302-9743). However, the secure equality test cannot be applied for solving the present problem for a number of reasons. First, if the entity identifiers were compared by the data sources applying the secure equality test, it would mean that each data source could discover which other data sources possess data on the entities on which the given data source has data records (for example, a bank could easily discover which of its clients have accounts at which other banks). This can be considered as extra information, so the pseudonymisation requirements are not met. On the other hand, in order to utilize the secure equality test for pseudonymisation, every entity identifier would have to be compared with every other entity identifier. From the aspect of computation complexity, this would be a protocol running in time O(n²), i.e., computation time would be squarely proportional to the number of data records to be pseudonymised. Thereby, the processing of new data records would take progressively more and more time, which cannot be tolerated in the long run.

A decentralised system for pseudonymisation according to the above is disclosed in the document WO 2021/009528 A1 that has already been mentioned. This known technical solution is significantly better suited to the objective than the above-mentioned solutions, but it does not entirely fulfil the requirements laid down in points 7.a) and 7.b) above. The present invention is intended to remedy these shortcomings.

It is not even a trivial undertaking to provide a data collection system wherein the collected data cannot be traced back to their origin. Attack vectors related to this can be for example:
A data source intentionally submits data records containing extreme or outlier data values such that it can easily find them among the collected data records.
An attacker eavesdrops on the network connections, and based on the traffic it infers the route of specific data.
A data source submits a data record at a time when the data collection system has low traffic so that it can safely assume that the next record appearing among the collected data records originates from it.

A well-known solution to the problems listed above is the application of mix networks (see David Chaum, Untraceable electronic mail, return addresses, and digital pseudonyms, Communications of the ACM, February 1981, Volume 24, Number 2). A distributed data collection system applying a mix network is disclosed for example in the document US 2011/0202764 A1. However, this prior art technical solution does not contain a pseudonymisation solution, so the collected data cannot be connected with each other on the basis of the entities they correspond to, at least not without compromising the anonymity of the entities.

In the technical solution disclosed in the document WO 2021/009528 A1 the mappers must know which key they are supposed to utilize in a given mapping process, for example they must know the unique identifier of the key to be utilized. This means that the last mapper in the mapping sequence will be able to see both the mapped pseudonym and the key utilized for generating it. This, in turn, opens up a possibility for data marking attack methods: although the generated pseudonym conceals the identity of the original entity, the key utilized for pseudonymisation works as a unique identifier, based on which the pseudonym can be potentially traced back to the unencrypted entity identifier. Such an attack can be implemented for example such that one of the mappers secretly colludes with a data source. If this mapper generates such a pseudonym that originally comes from the data source colluding with it, it is enough for the data source to know which key was used by the mapper for generating the given pseudonym. In case there is a large number of mappers in the system, such a cooperation can succeed only rarely, but on some occasions it can be successful.

One of the possibilities for preventing that is to occasionally utilize the same key for more than one pseudonyms. This, however, causes further problems, for example that a data source will sometimes submit the same encrypted identifier more than once—from which it becomes evident that it submitted data on the same entity on both occasions. The problem fundamentally stems from the fact that information on the keys that are to be applied for mapping the given pseudonym is shared with the mappers.

Another (and even more fundamental) problem related to the solution described in the document WO 2021/009528 A1 is that the system is vulnerable against the so-called “chosen plaintext” attacks: if a malicious data source intends to discover the pseudonym corresponding to an entity identifier D, all it has to do is randomly select an integer m, and request the pseudonymisation of the identifiers D and D^{m} mod N. Of course, the latter will almost never be an identifier corresponding to a real entity, however this cannot be checked by the other participants of the mapping as it is seen by them only in encrypted form. These values will generate the pseudonyms D^{b} mod N and D^{mb mod φ(N)} mod N, respectively. This means that in case the data source carrying out the attack finds among the mapped pseudonyms such a value P₁ and a value P₂ that (P₁)^{m}≡P₂ mod N, then it can be almost sure that P₁ is the pseudonym generated from the entity identifier D. Moreover, because the value of m is known only by the attacker, the other entities participating in the mapping will not even know that there has been an attack.

The latter vulnerability follows directly from the formula defining the mapping of the identifiers to the pseudonyms, i.e., it is an inherent property thereof. Therefore, two mitigation options suggest themselves.

Firstly, such organisational measures must be taken—in line with the principles of data protection—which provide that the mappers can never access the unencrypted identifiers, and that no other entities but the mappers can access the pseudonyms. Any entity that intends to analyse the pseudonymised data will receive data mapped utilizing an encryption key generated for the purposes of the given data request. This must be applied in the manner described in relation to the report key (ak.rep.i.enc) defined in the document WO 2017/141065 A1. In the case of such a restricted-access pseudonymised database it is also possible to individually assess the properties of the submitted information from the aspect of whether the entity performing data analysis will be able to repeatedly assign certain elements of the information to the entity (for example, natural person), to which they originally belonged. In this case, such metrics or a combination thereof may also be applied to the data waiting to be submitted as for example the k-anonymity, I-diversity, unique subnetwork topology, etc., with the help of which the risk can be assessed objectively.

If it is not feasible to protect the pseudonymised database against access by entities other than the mappers, then it is not enough to modify only the steps of the process, i.e., the formula defining pseudonymisation must also be reconsidered—in such cases the selection of attributes attached to the pseudonyms in unencrypted form must be performed carefully—such that it is not possible to use those for data marking.

A cryptographic algorithm applying ElGamal public keys for data submission is disclosed in the following conference publication: Zengqiang Wu et al.: ElGamal Algorithm for Encryption of Data Transmission, 2014, International Conference on Mechatronics and Control (ICMC), IEEE, https://doi.org/10.1109/ICMC.2014.7231798, 3 Sep. 2015.

A cryptographic communication method utilizing public key encryption is disclosed in the document US 2002/0041684 A1.

The prior art documents—either in themselves or in combination—do not refer to the possibility that, through the application of suitable mathematical structures the cyclic group forming the message space of an ElGamal-type encryption system can serve as a subgroup of an automorphism group of another cyclic group, such that the solution of the Diffie-Hellman decision problem is not known for either algebraic group (preferably both algebraic groups are Schnorr groups), so the security of the ElGamal ciphers or the anonymity provided by the pseudonyms generated from the messages contained in the ElGamal ciphers is not compromised in the process. In lack of such mathematical structures, the prior art technical solutions may qualify as being vulnerable to exponent-attributing types chosen plaintext and chosen ciphertext attacks.

The primary objective of the present invention is to provide that the anonymity of the pseudonymised entities is protected cryptographically even in the case of a malicious collusion between a data source and a mapper. Another objective of the invention is to provide protection against any such cryptographical attacks that are protected against by the prior art technical solution—i.e., among others, against “brute force” attacks. Another objective of the invention is to exploit the advantages offered by mix networks.

The present invention therefore essentially intends to solve similar problems as the technical solutions disclosed in the document WO 2021/009528 A1 and the document WO 2017/141065 A1 referenced therein, but at the same time it also aims at providing that the secure operation of the system does not require additional organizational regulations, i.e., that each participating entity is able to control their own data security.

In most real-world situations the database also stores the attributes of the entities in addition to their identifiers (e.g., the data source is a plasma company, the entities are the donors, and the stored entity attribute is the yearly number of plasma donations by the given donor at the given plasma company). In many cases the attribute itself carries sufficient information for identifying the given entity. In such situations it is considered a security risk endangering the anonymity of the pseudonyms to attach the attribute to the pseudonym in an unaltered form. Therefore, if the field of application requires storing attributes in addition to the pseudonyms, it is not sufficient to pseudonymise only the entity identifiers, but the attributes must also be transformed such that they cannot be applied for differentiating between the entities.

One of the ways to achieve that is to reduce the accuracy of the attributes (for example, if the attribute is a GPS coordinate, accuracy can be reduced by omitting the last few digits) until the resulting attribute value is not accurate enough for identification. However, the actual anonymity of the entities it is not guaranteed even by this method, and in many cases the deterioration of the quality of the attributes is not allowable.

It is therefore expedient to devise such a partial solution that—in parallel with the calculation of the pseudonyms—encrypts the attributes in such a manner that neither of the entities participating in the system are able to decrypt even one of them on its own, and that the decryption of any attribute can be performed only by the mutual consent of all mappers. It should be noted that this partial solution is not a mandatory element of the invention, i.e., it is included optionally in the pseudonymisation process, and its steps can be carried out simultaneously or alternating with the steps of the pseudonymisation process. This encryption preferably also has a homomorphic property allowing that simple calculations (e.g., multiplication) can be performed on the encrypted attributes without decrypting them while also allowing that the results—and only the results—of the calculation can be decrypted. In comparison with the application of unencrypted attributes, this is preferable because unencrypted attributes can be utilized for data marking attacks, and also because utilizing homomorphic encryption allows that the concrete data points utilized during the calculations are never made public, so overall less such information is generated that might jeopardize the anonymity of the data.

### DESCRIPTION OF THE INVENTION

The primary object of the present invention is therefore to provide a cryptographic pseudonym mapping method that is based on the prior art technical solutions and is able to remedy both of the previously mentioned vulnerabilities.

The objects of the invention have been fulfilled by providing the cryptographic pseudonym mapping method according to claim 1, the computer system according to claim 26, the computer program according to claim 30, and the computer-readable medium according to claim 31. Preferred embodiments of the invention are defined in the dependent claims.

For implementing the invention such a public key encryption system is required that can be defined over any cyclic group and supports:
a. the secure generation of such a public key, from an arbitrary number of private keys, that its ciphers can only be decrypted by performing a chain of decryption operations applying all of the applied private keys (in an arbitrary order),
b. the randomization of a cipher (i.e., the modification thereof such that it encodes the same message and, knowing the previous cipher, it is still indistinguishable from a cipher encoding a random value),
c. the homomorphic multiplication of a cipher by group element,
d. the homomorphic exponentiation of a cipher.

According to the invention, the ElGamal-type public key encryption system has all these properties and is thus excellently suited for application for the purposes of the invention.

The present invention has been provided expressly for eliminating the above-described chosen-plaintext/chosen-ciphertext vulnerabilities affecting the method disclosed in the document WO 2021/009528 A1, and for eliminating further vulnerabilities potentially arising therefrom. These vulnerabilities cannot be eliminated solely by the application of the ElGamal-type encryption system, as the ElGamal-type encryption system is itself vulnerable to chosen-ciphertext attacks. According to the invention, the ElGamal encryption system is applied in an indirect manner, for calculating such a function (see the equations 2.0.1 and 2.0.2 below) against which such attack types are not successful.

In comparison with the system described in the document WO 2021/009528 A1, the system is characterised by the following:
1. The formula defining the mapping of the identifiers to pseudonyms is chosen such that any arithmetic relationships between two or more identifiers should be undetectable based on the pseudonyms generated therefrom without knowing the secret keys of the mapping. Thus, for example, in case an entity identifier D and its square are both pseudonymised, there will not be any unique mathematical relationship between the generated pseudonyms. Thereby, the system will not be vulnerable against “chosen plaintext” attacks exploiting such mathematical relationships—while in the case of the technical solution according to WO 2021/009528 A1 such attacks—although detectable in certain situations (for example in case the fake identifier causes a detectable anomaly in the distribution or topology of the pseudonyms)—cannot be prevented or defended against.
2. Such an algorithm is applied by the data sources and the mappers for generating the unique keys actually utilized by them from the random numbers they generate and keep secret that it is not necessary to identify them. Thus, the data source does not need to attach (assign) the unique identifier of the key applied for encryption to the encrypted entity identifier, which identifier could be potentially utilized for a data marking attack.

Even if such a system includes only a single honest mapper, then it is not possible to establish a relationship between the entity identifier and the pseudonym. This cannot be maintained of the system according to WO 2021/009528 A1, wherein a collusion between even only a single malicious mapper and a data source allows the generation of a rainbow table, and thereby the cracking of anonymity; however, the fact that other entities also participate in performing the mappings guarantees that a brute force attack cannot go undetected.

In addition to transforming static databases, the present invention also relates to the transformation databases updated time-to-time. For example, such databases may include hotel guest databases wherein new data are regularly entered as new guests are received. In the case of such regularly updated databases the method described in this specification is able to transform the new data records consistently with previously generated ones. The present invention is also related to the transformation of data streams. (By “data stream”, in this case there is meant a sequence of information-representing digitally encoded signals being transmitted or broadcast.)

### BRIEF DESCRIPTION OF THE DRAWINGS

Preferred embodiments of the invention are described hereinafter by way of example with reference to the following drawings, where

FIGS. 1A, 1B are schematic diagrams of the generation process of a first ElGamal public key applying a solution according to the invention,

FIGS. 2A, 2B show schematic diagrams of the generation process of a second ElGamal public key applying a solution according to the invention,

FIGS. 3A, 3B show schematic diagrams of the generation process of ElGamal ciphers adapted to be decrypted utilizing ElGamal private keys in a solution according to the invention, and

FIGS. 4A, 4B, 4C show schematic diagrams of the mapping process applied in a technical solution according to the invention.

### MODES FOR CARRYING OUT THE INVENTION

Like in the technical solution set forth in the document WO 2021/009528 A1, it is supposed that the system consists of more than one (a number n of) data sources and more than one (a number k of) mappers. The data sources will hereinafter be denoted by DSᵢ, with the mappers being denoted by Mⱼ—therefore, DS₁, DS₂, . . . DSₙ denotes a series of all data sources, while M₁, M₂, . . . Mₖ denotes a series of all mappers.

### Cryptographic Structure

The basis of the pseudonymisation method is formed by an algebraic group G (which is a cyclic group) and a set H which is a subset of integers being coprime to φ that forms an algebraic group with regard to modulo φ multiplication. For carrying out the method it is not necessary (and it is even practically impossible) to list all the elements of the group G or the set H; it is sufficient if there exists an effective algorithm that is able to decide whether a given object is an element of the group G or of the set H.

The order (i.e., the number of the elements) of the group G will be denoted in this document by the symbol φ, with a generator element g being also designated in the group G.

A further basis of the pseudonymisation system is formed by a mapping

$$h : ℕ \to \{ 0 , 1 , 2 , ... , ( φ - 1 ) \}$$

where [symbol] denotes the set of nonnegative integer numbers. For example, this can be a cryptographic hash function (see e.g., in Wikipedia), or even the modulo φ function (yielding h(x)=x mod φ for each nonnegative integer x). It is strongly recommended, i.e., preferable, that h be a cryptographic hash function.

### Denotations

If a and b are integers, then the expression (a,b) denotes in all cases the ordered pair consisting of the numbers a, b.

In this document, ElGamal encryption is defined over the modulo cp multiplicative group of integers, therefore:
By an ElGamal private key, a positive integer between 1 and φ is meant.
By an ElGamal public key such a number pair K=(w,z) is meant where w and z are both integers that are relatively prime to φ. In this case, the integers w and z are called the components of the ElGamal public key K.
By an ElGamal cipher such a number pair C=(c₁, c₂) is meant where c₁ and c₂ are both integers that are relatively prime to φ. In this case, the integers c₁ and c₂ are called the components of the ElGamal cipher C.

### ElGamal Encryption

If K=(w,z) is an ElGamal public key, then in this document the expression ElGamalEnc_{K}(m) denotes the cipher of the message m generated utilizing the key K applying ElGamal encryption over the modulo φ multiplicative group of integers, i.e.:

$${ElGamalEnc}_{K} ( m ) = ( {w}^{y} mod φ , m \cdot {z}^{y} mod φ ) ,$$

where the value of y is an integer number chosen randomly between 1 and φ with a uniform distribution by the entity performing the encryption (this is an ephemeral key, i.e., a different value must be chosen each time).

### Decryption (Partial Decryption) of an ElGamal Cipher

If C=(c₁, c₂) is an ElGamal cipher and x is an ElGamal private key, then the expression ElGamalPartialDecₓ(C) means the following:

$${ElGamalPartialDec}_{x} ( C ) = ( {c}_{1}^{x} mod φ , {c}_{2} )$$

### Resolving an ElGamal Cipher

If C=(c₁, c₂) is an ElGamal cipher, then the expression ElGamalResolve(C) denotes the following value:

$$ElGamalResolve ( C ) = ( ( {( {c}_{1} )}^{- 1} mod φ ) \cdot {c}_{2} ) mod φ$$

Here, the expression (c)⁻¹ mod φ denotes the multiplicative inverse modulo φ of the value c₁. This value can be generated for example by applying the Euclidean algorithm.

### Rerandomization of an ElGamal Cipher

If C=(c₁, c₂) is an ElGamal cipher and K=(w,z) is an ElGamal public key, then the expression ElGamalRerand_{K}(C) denotes the rerandomization of the cipher C, i.e.:

$${ElGamalRerand}_{K} ( C ) = ( {c}_{1} \cdot {w}^{y} mod φ , {c}_{2} \cdot {z}^{y} mod φ ) ,$$

where the value of y is an integer number chosen randomly between 1 and φ with a uniform distribution by the entity performing the rerandomization (this is an ephemeral key, i.e., a different value must be chosen each time).

### Rerandomization of an ElGamal Key

If K=(w,z) is an ElGamal public key, then the expression ElGamalKeyRerand(K) denotes the rerandomization of the key K, i.e.:

$$ElGamalKeyRerand ( K ) = ( {w}^{y} mod φ , {z}^{y} mod φ ) ,$$

where the value of y is an integer number chosen randomly between 1 and φ with a uniform distribution by the entity performing the rerandomization (this is an ephemeral key, i.e., a different value must be chosen each time).

### Multiplication by a Scalar of an ElGamal Cipher

If C=(c₁, c₂) is an ElGamal cipher and X is an arbitrary integer, then the expression C⊗λ is used for denoting the product by the scalar λ of the cipher C, i.e.:

$$C ⊗ λ = ( {c}_{1} , {c}_{2} \cdot λmodφ )$$

### Exponentiation of an ElGamal Cipher

If C=(c₁, c₂) is an ElGamal cipher and λ is an arbitrary integer, then the expression C^{λ} is used for denoting the λ-th power of the cipher C, i.e.:

$${C}^{λ} = ( {c}_{1}^{λ} mod φ , {c}_{2}^{λ} mod φ )$$

### Addition of a Private Key to an ElGamal Public Key

If K=(w,z) is an ElGamal public key and x is an ElGamal private key, then the expression K⊗x denotes the following pair of values:

$$K ⊕ x = ( w , {z}^{x} mod φ )$$

Removal of a Private Key from an ElGamal Public Key

If K=(w,z) is an ElGamal public key and x is an ElGamal private key, then the expression K⊖x denotes the following pair of values:

$$K ⊖ x = ( {w}^{x} mod φ , z )$$

### Equivalence of ElGamal Ciphers

If x is an ElGamal private key and B and C are ElGamal ciphers, then the expression

$$B {≅}^{x} C$$

denotes the following statement:

$$ElGamalResolve ( {ElGamalDecrypt}_{x} ( B ) ) = ElGamalResolve ( {ElGamalDecrypt}_{x} ( C ) )$$

Informally, this can be phrased as the ciphers B and C “encode” the same message.

### Key Exchange Process

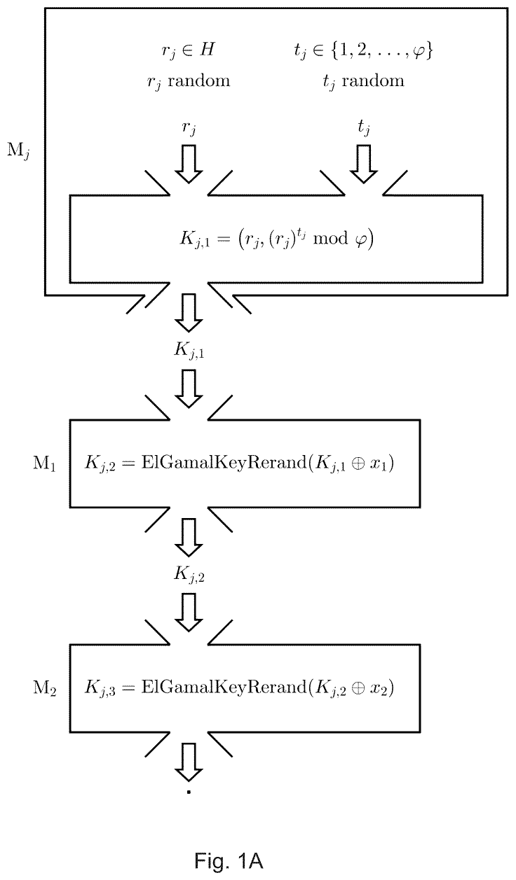

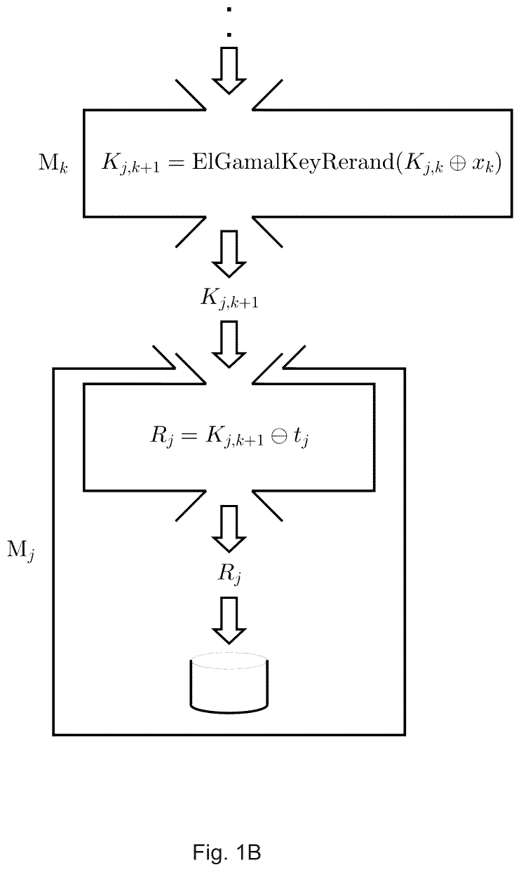

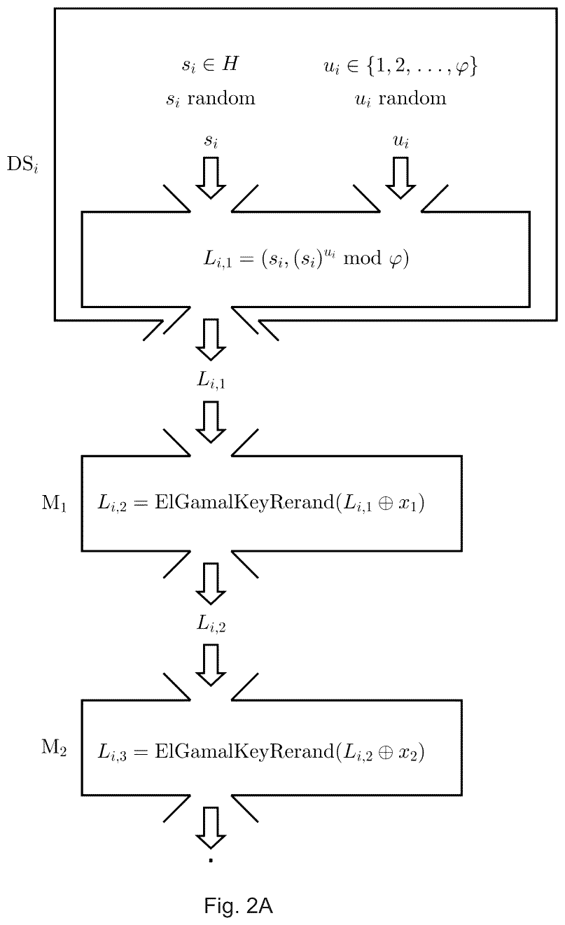

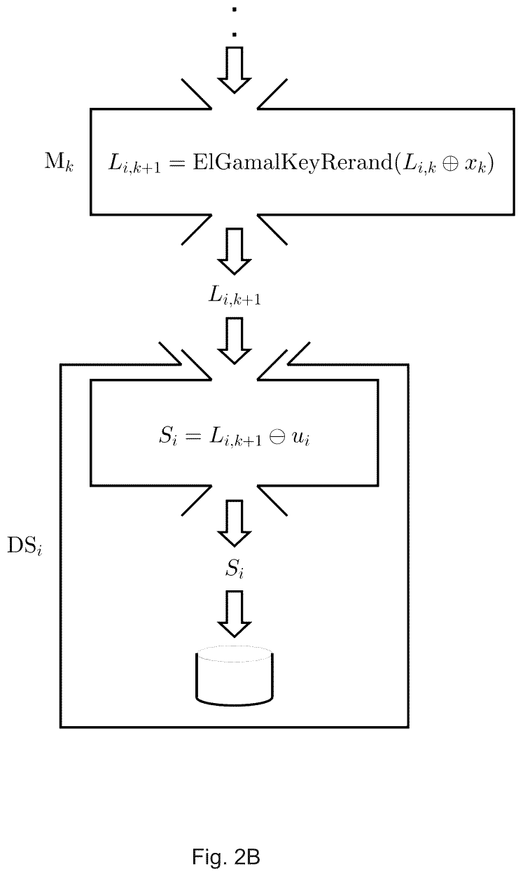

Preparing the pseudonymisation system requires the preparation of the keys of the mappers Mⱼ and the data sources DSᵢ. In this section, the steps of this process are described in relation to FIGS. 1A-1B, and FIGS. 2A-2B.

According to the invention, by random selection it is meant that the implementation of the method is not dependent on the particular elements of the given set that are chosen. Accordingly, random selection is meant to include also quasi-random or pseudo-random selection, as well as all such selection methods (even according to rules unknown to an observer) wherein the selection appears to be random to the outside observer. If the set constitutes an algebraic structure, then, if it has a null element and/or a unit element, then it/they are not regarded as randomly selected. However, for cryptography considerations it is worth selecting values for which the bit length of their representation fills up all the available space.

### Generation of Private Keys

The following two steps must be performed for each index j=1, 2, . . . , k:
1.1.1 The mapper Mⱼ randomly selects for itself—preferably according to a uniform distribution—an integer xⱼ and an integer αⱼ between 2 and φ. These values are chosen independently of each other.
1.1.2 The mapper Mⱼ randomly selects for itself—preferably according to a uniform distribution—an integer bⱼ from the set H.

The values bⱼ, xⱼ, and αⱼ are kept secret by the mapper Mⱼ because they are qualified as secret cryptographic keys.

The values bⱼ, xⱼ, and αⱼ cannot be changed during the pseudonymisation process.

### Exchange of the Distributed ElGamal Keys of Mappers (FIGS. 1A and 1B)

The following steps must be carried out for each index j=1, 2, . . . , k:
1.2.1 The mapper Mⱼ randomly chooses—preferably according to a uniform distribution—an integer rⱼ between 1 and φ from the set H.
1.2.2 The mapper Mⱼ randomly chooses—preferably according to a uniform distribution—an integer tⱼ between 1 and φ.
1.2.3 The mapper Mⱼ generates the ElGamal public key K_{j,1}=(rⱼ, (rⱼ)^{t}^{ⱼ} mod φ).
1.2.4 The mapper Mⱼ sends the public key K_{j,1} to the mapper M₁ (if j=1, this step can be omitted).
1.2.5 For each index τ=1, 2, . . . , k, in this order, the mapper M_{τ} checks if the first and second components of the ElGamal public key K_{j,τ} are elements of the set H, and, if the result of the check is positive, it calculates the public key K_{j,τ+1}=ElGamalKeyRerand(K_{j,τ}⊗x_{τ}) from the ElGamal public key K_{j,τ}, and, if τ<k, sends it to the mapper M_{τ+1}.
1.2.6 The mapper Mₖ sends the ElGamal public key K_{j,k+1} to the mapper Mⱼ.
1.2.7 The mapper Mⱼ generates and stores the first ElGamal public key Rⱼ=K_{j,k+1}⊕tⱼ.

Note: for each index j=1, 2, . . . , k the key Rⱼ is a public key corresponding to the ElGamal private key x₁·x₂· . . . ·xₖ.

Key exchange of the distributed ElGamal keys of the data sources (FIGS. 2A and 2B) The following steps must be carried out for each index i=1, 2, . . . , n:
1.3.1 The data source DSᵢ randomly chooses—preferably according to a uniform distribution—an integer sᵢ between 1 and φ from the set H.
1.3.2 The data source DSᵢ randomly chooses—preferably according to a uniform distribution—an integer uᵢ between 1 and φ.
1.3.3 The data source DSᵢ generates the ElGamal public key L_{i,1}=(sᵢ, (sᵢ)^{u}^{ᵢ} mod φ).
1.3.4 The data source DSᵢ sends the ElGamal public key L_{i,1} to the mapper M₁.
1.3.5 For each index τ=1, 2, . . . , k, in this order, the mapper M_{τ} checks if the first and second components of the ElGamal public key L_{i,τ} are elements of the set H, and, if the result of the check is positive, it calculates the public key L_{i,τ+1}=ElGamalKeyRerand(L_{i,τ}⊗x_{τ}) from the ElGamal public key L_{i,τ}, and, if τ<k, sends it to the mapper M_{τ+1}.
1.3.6 The mapper Mₖ sends the ElGamal public key L_{i,k+1} to the data source DSᵢ.
1.3.7 The data source DSᵢ generates and stores the second ElGamal public key

$${S}_{i} = {L}_{i , k + 1} ⊖ {u}_{i} .$$

Note: for each index i=1, 2, . . . , n the key Sᵢ is a public key corresponding to the ElGamal private key x₁·x₂· . . . ·xₖ.

The mapping h adapted to assign integer numbers to the entity identifiers is required in order that the entity identifier D is converted to a form that can be interpreted by the mathematical function defining pseudonymisation. The first and second ElGamal public keys Rᵢ, Sᵢ are in turn adapted for securely calculating the mathematical function defining pseudonymisation.

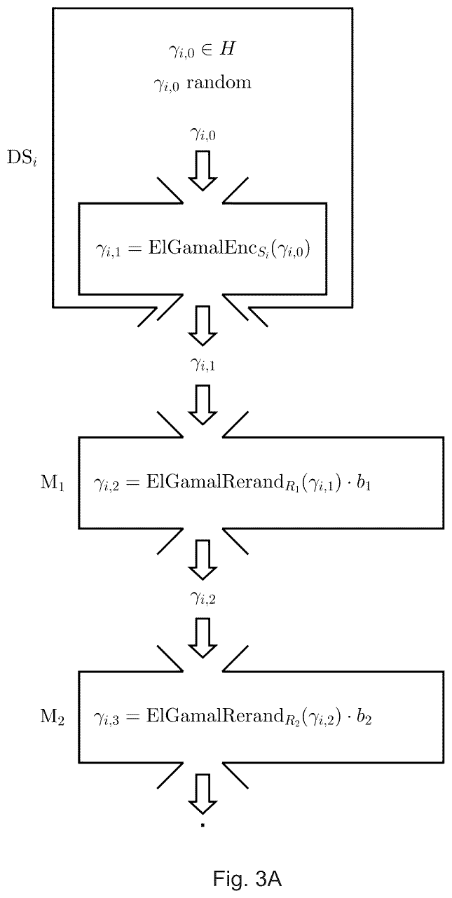

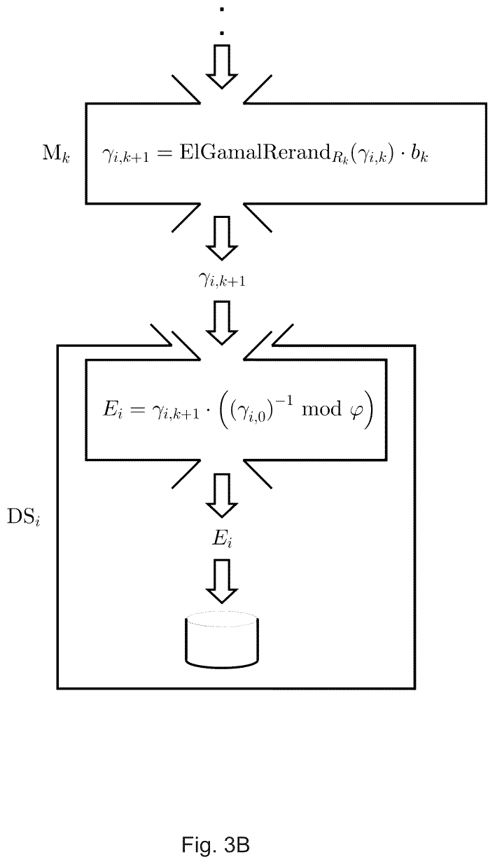

### Exchange of Distributed ElGamal Ciphers (FIGS. 3A and 3B)

The following steps must be carried out for each index i=1, 2, . . . , n:
1.4.1 The data source DSᵢ randomly chooses—preferably according to a uniform distribution—a value γ_{i,0} from the set H.
1.4.2 The data source DSᵢ generates the cipher γ_{i,1}=ElGamalEncₛ_{ᵢ}(γ_{i,0}).
1.4.3 The data source DSᵢ sends the cipher γ_{i,1} to the mapper M₁.
1.4.4 For each index j=1, 2, . . . , k, in this order, the mapper Mⱼ checks if the first and second components of the ElGamal cipher γ_{i,1} are elements of the set H, and, if the result of the check is positive, it calculates the cipher γ_{i,j+1}=ElGamalRerand_{R}_{ⱼ}(γ_{i,j})·bⱼ from the ElGamal cipher γ_{i,j}, and, if j<k, sends the cipher γ_{i,j+1} to the mapper Mⱼ₊₁.
1.4.5 The mapper Mₖ sends the cipher γ_{i,k+1} to the data source DSᵢ.
1.4.6 The data source DSᵢ generates and stores the cipher Eᵢ=γ_{i,k+1}·((γ_{i,0})⁻¹ mod φ).

Note: it can be seen that for each index i=1, 2, . . . , n

$${E}_{i} {≅}^{{x}_{1} \cdot {x}_{2} \cdot ... \cdot {x}_{k}} {ElGamalEnc}_{{s}_{i}} ( {b}_{1} \cdot {b}_{2} \cdot … \cdot {b}_{k} )$$

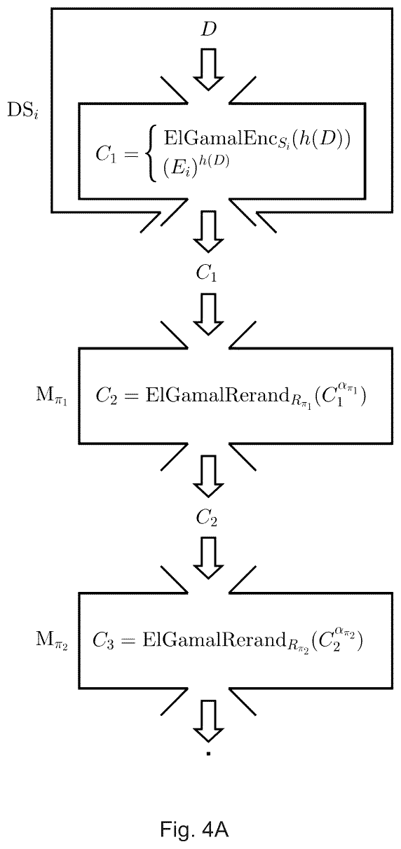

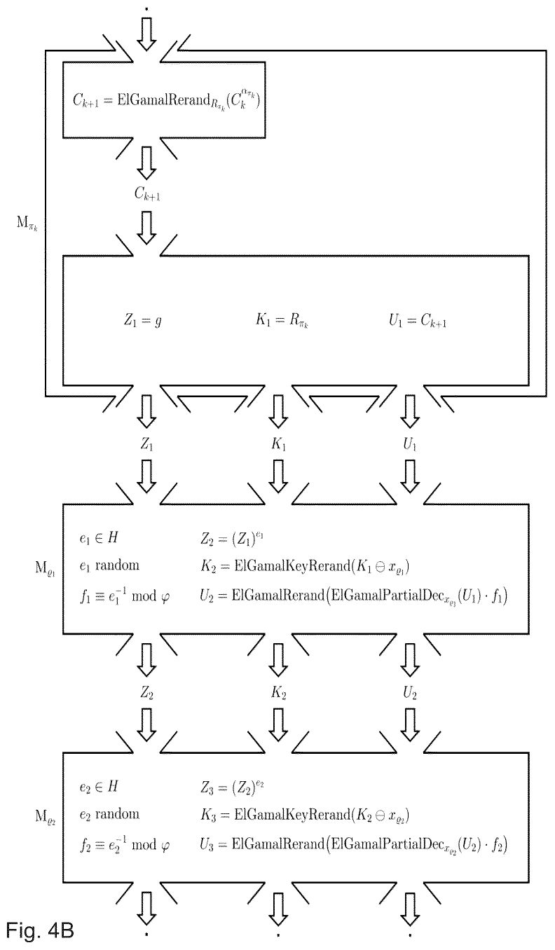

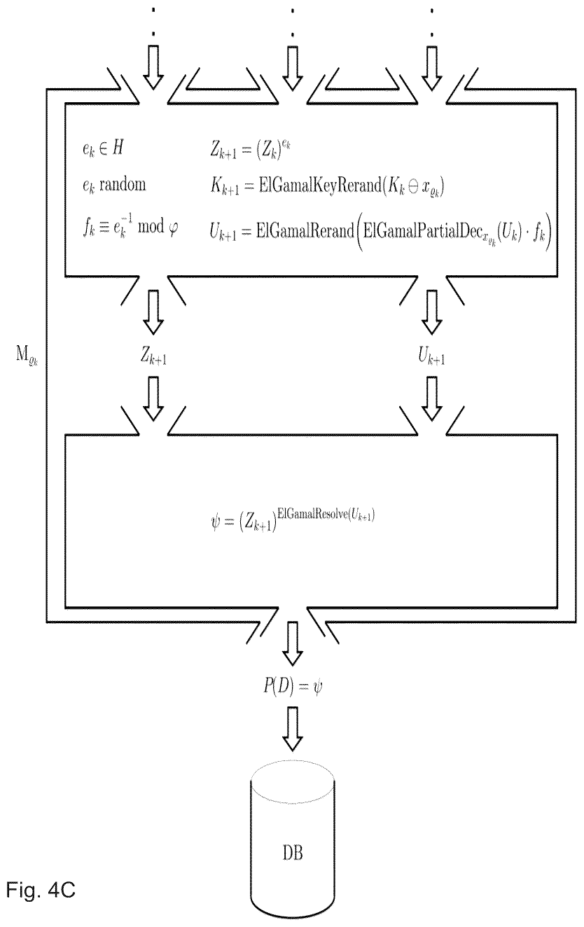

### Pseudonymisation Process (FIGS. 4A, 4B and 4C)

Two alternatives are presented for defining the function adapted for mapping the entity identifiers to pseudonyms. For implementing the system, a decision must be made on which of the two alternatives will be utilized.

The pseudonym assigned by the system to the entity identifier D will hereinafter be denoted by P(D).

### Pseudonymisation Function, First Alternative:

$$P ( D ) = {g}^{( {h ( D )}^{{α}_{1} \cdot {α}_{2} \cdot ... \cdot {α}_{k}} mod φ )} , \qquad ( 2. \text{.1} )$$

where the range of the function h is a subset of the set H.

### Pseudonymisation Function, Second Alternative:

$$P ( D ) = {g}^{( {( {b}_{1} \cdot {b}_{2} \cdot … \cdot {b}_{k} )}^{h ( D ) \cdot {α}_{1} \cdot {α}_{2} \cdot ... \cdot {α}_{k}} mod φ )} \qquad ( 2. \text{.2} )$$

For pseudonymisation it is not necessary to utilize the ElGamal-type encryption system, because the pseudonym values are defined by the functions according to the above-described alternatives, and neither of the functions can be derived solely from the ElGamal-type encryption system. The mapping adapted for assigning pseudonyms to the entity identifiers is therefore basically not resulting from the ElGamal-type encryption system. In the course of the method described in the present invention, the mathematical operations required for calculating the formulas 2.0.1 and 2.0.2 (modular multiplication, modular exponentiation) are not obtained as a direct output of the ElGamal-type encryption system but rather due to the homomorphic properties of the ElGamal-type encryption system, i.e., thanks to the fact that the ElGamal-type encryption system is homomorphic with regard to exponentiation and to multiplication by a group element. The ElGamal-type encryption system is included in the invention not because it is required for generating the pseudonyms, but in order that the pseudonyms can be generated in a secure manner, i.e., without the participants of the process gaining any extra information during the interaction. The significance of the invention does not exclusively stem from the method being adapted for securely generating the pseudonyms, but first and foremost from the cryptographic strength of the pseudonyms themselves, including their resistance to exponent marking attacks.

### Data Submission Step

In this step, one of the data sources (hereinafter: DSᵢ) initiates the pseudonymisation of an entity identifier D in its possession. This is performed in the following manner:
2.1.1 The data source DSᵢ calculates an ElGamal cipher C₁ according to one of the following two alternatives:
   2.1.1.1 In case the first alternative (2.0.1) of the pseudonymisation function is applied, the definition of the ElGamal cipher C₁ is:

$${C}_{1} = {ElGamalEnc}_{{S}_{i}} ( h ( D ) )$$

2.1.1.2 In case the second alternative (2.0.2) of the pseudonymisation function is applied, the ElGamal cipher C₁ is defined as:

$${C}_{1} = {( {E}_{i} )}^{h ( D )}$$

(see the section Exponentiation of an ElGamal cipher).
2.1.2 The data source DSᵢ randomly chooses—preferably according to a uniform distribution—a value π₁ from among the numbers 1,2, . . . , k.
2.1.3 The data source DSᵢ sends the cipher C₁ to the mapper M_{π}_{₁}.

### Randomization Step

This step has two objectives:
To ensure that, if the entity identifier D or the cipher C₁ is manipulated (altered) by the data source DSᵢ in the submission step (chosen plaintext or chosen ciphertext attack), the attacker is not able to gain such information that would enable it to find out or correctly guess the pseudonym corresponding to an identifier (with a probability higher than that of choosing randomly from the set of all pseudonyms).
To transform the cipher C₁ such that no entity (including the data source DSᵢ) is able to guess which data source is the originator of the cipher.

This step is performed by the mappers carrying out the following operations for each index j=1, 2, . . . , k in the following order:
2.2.1 The mapper M_{π}_{ⱼ} checks if the first and second components of the ElGamal cipher Cⱼ are elements of the set H, and only continues the process if the result of the check is positive.
2.2.2 The mapper M_{π}_{ⱼ} calculates the cipher

$${C}_{j + 1} = {{ElGamalRerand}_{R}}_{{π}_{j}} ( {( {C}_{j} )}^{{α}_{{π}_{j}}} ) .$$

2.2.2. If j<k, then the mapper M_{π}_{ⱼ} randomly selects—preferably according to a uniform distribution—from the numbers 1, 2, . . . , k such a number πⱼ₊₁ that is not among the numbers π₁, π₂, . . . , πⱼ, and then sends in a message the cipher Cⱼ₊₁ to the mapper M_{πj+1}.
2.2.3. If, in turn, j=k, then the mapper M_{π}_{ⱼ} randomly selects—preferably according to a uniform distribution—from the numbers 1,2, . . . , k a number [symbol] ₁, and sends to the mapper [symbol] the following in a message:

$${Z}_{1} = g$$

$${K}_{1} = {R}_{{π}_{k}}$$

$${U}_{1} = {C}_{k + 1}$$

The rerandomization step is thereby completed.

### Pseudonym Decryption Step

In this step, the cipher U₁ is decrypted by the mappers such that the decrypted value itself is never known, only the result of exponentiating the generator element g utilizing this value as an exponent is published.

The following operations must be performed for each index j=1, 2, . . . , k, in this order:
2.3.1 The mapper M_{π}_{ⱼ} checks if the first and second components of the ElGamal cipher Uⱼ are elements of the set H, and only continues the process if the result of the check is positive.
2.3.2 The mapper M_{π}_{ⱼ} checks if the first and second components of the ElGamal public key Kⱼ are elements of the set H, and only continues the process if the result of the check is positive.
2.3.3 The mapper [symbol] randomly—preferably according to a uniform distribution—chooses an integer eⱼ from the set H, and determines an integer fⱼ such that:

$${e}_{j} \cdot {f}_{j} ≡ 1 mod φ$$

Such a value f can be found for example applying the Euclidean algorithm.
2.3.4 The mapper [symbol] calculates the following values:

$${Z}_{j + 1} = {( {Z}_{j} )}^{{e}_{j}}$$

$${K}_{j + 1} = ElGamalKeyRerand ( {K}_{j} ⊖ {x}_{{ϱ}_{j}} )$$

$${U}_{j + 1} = {ElGamalRerand}_{{K}_{j + 1}} ( {ElGamalPartialDec}_{{x}_{{ϱ}_{j}}} ( {U}_{j} ) \cdot {f}_{j} )$$

(By the exponentiation of Zⱼ, in this case the group operation, i.e., exponentiation defined over G is meant.)
2.3.5. If j<k, then the mapper [symbol] randomly selects—preferably according to a uniform distribution—from the numbers 1, 2, . . . , k such a number [symbol] that is not among the numbers [symbol] , [symbol] , . . . , [symbol] , and then sends in a message the value Zⱼ₊₁, the key Kⱼ₊₁, and the cipher Uⱼ₊₁ to the mapper [symbol] .
2.3.6. If j=k, then the mapper [symbol] generates the following value:

$$ψ = {( {Z}_{k + 1} )}^{ElGamalResolve ( {U}_{j + 1} )}$$

(By the exponentiation of Zₖ₊₁, in this case the group operation, i.e., exponentiation defined over G is meant.)
This value ψ is the pseudonym corresponding to the identifier D.

### Correctness of the Pseudonym

In the following we sketch a proof for the value ψ generated by the method presented in the previous section being equal to the value according to the appropriate definition (2.0.1 or 2.0.2) of P(D).

It can be easily seen that if K is a public key corresponding to the ElGamal private key x, m is an arbitrary integer, λ is a positive integer, and C=ElGamalEnc_{K}(m), then the following equivalences hold:

$${ElGamalRerand}_{K} ( C ) {≅}^{x} C \qquad ( 3.1 )$$

$${ElGamalRerand}_{ElGamalKeyRerand ( K )} ( C ) {≅}^{x} C \qquad ( 3.2 )$$

$${ElGamalEnc}_{K} ( {m}^{λ} ) {≅}^{x} {C}^{λ} \qquad ( 3.3 )$$

$${ElGamalEnc}_{K} ( m \cdot λ ) {≅}^{x} C \cdot λ \qquad ( 3.4 )$$

$${ElGamalPartialDec}_{t} ( C ) {≅}^{x \cdot {t}^{- 1} mod φ} {ElGamalEnc}_{K ⊖ t} ( m ) \qquad ( 3.5 )$$

Applying the equivalences 3.1 and 3.3, from the steps 2.2.1, 2.2.2, and 2.2.3 it follows by induction that for each index j=1, 2, . . . , k:

$${C}_{j + 1} {≅}^{{x}_{1} \cdot {x}_{2} \cdot … \cdot {x}_{k}} {( {C}_{1} )}^{{α}_{{π}_{1}} \cdot {α}_{{π}_{2}} \cdot … \cdot {α}_{{π}_{j}}} \qquad ( 3.6 )$$

Specially:

$${C}_{j + 1} {≅}^{{x}_{1} \cdot {x}_{2} \cdot … \cdot {x}_{k}} {( {C}_{1} )}^{{α}_{{π}_{1}} \cdot {α}_{{π}_{2}} \cdot … \cdot {α}_{{π}_{j}}} = {( {C}_{1} )}^{{α}_{1} \cdot {α}_{2} \cdot … \cdot {α}_{k}} \qquad ( 3.7 )$$

With the help of the properties 3.2, 3.4, and 3.5, based on the steps 2.3.2, 2.3.3, 2.3.4 it can be obtained by induction that for each index j=1, 2, . . . , k:

$${U}_{j + 1} {≅}^{{x}_{{ϱ}_{j + 1}} \cdot {x}_{{ϱ}_{j + 2}} \cdot … \cdot {x}_{{ϱ}_{k}}} {ElGamalPartialDec}_{{x}_{{ϱ}_{1}} \cdot {x}_{{ϱ}_{2}} \cdot … \cdot {x}_{{ϱ}_{j}}} ( {C}_{k + 1} ) \cdot {f}_{1} \cdot {f}_{2} \cdot … \cdot {f}_{j} \qquad ( 3.8 )$$

Substituting equivalence 3.7 and considering the case j=k:

$$ElGamalResolve ( {U}_{k + 1} ) = ElGamalResolve ( {ElGamalPartialDec}_{1} ( {U}_{k + 1} ) ) = {ElGamalResolve ( {ElGamalPartialDec}_{{x}_{1} \cdot {x}_{2} \cdot … \cdot {x}_{k}} ( {C}_{1} ) )}^{{α}_{1} \cdot {α}_{2} \cdot … \cdot {α}_{k}} \cdot {f}_{1} \cdot {f}_{2} \cdot … \cdot {f}_{k}$$

based on the definition of Zⱼ₊₁ it is obvious that:

$${Z}_{k + 1} = {g}^{{e}_{1} \cdot {e}_{2} \cdot … \cdot {e}_{k}}$$

Applying the previous two equations and the Euler-Fermat theorem:

$${( {Z}_{k + 1} )}^{ElGamalResolve ( {U}_{k + 1} )} = {g}^{( {e}_{1} \cdot {e}_{2} \cdot … \cdot {e}_{k} \cdot {f}_{1} \cdot {f}_{2} \cdot … \cdot {f}_{k} \cdot {ElGamalResolve ( {ElGamalPartialDec}_{{x}_{1} \cdot {x}_{2} \cdot … \cdot {x}_{k}} ( {C}_{1} ) )}^{{α}_{1} \cdot {α}_{2} \cdot … \cdot {α}_{k}} )} = {g}^{( {ElGamalResolve ( {ElGamalPartialDec}_{{x}_{1} \cdot {x}_{2} \cdot … \cdot {x}_{k}} ( {C}_{1} ) )}^{{α}_{1} \cdot {α}_{2} \cdot … \cdot {α}_{k}} )}$$

If the pseudonymisation function according to the equation 2.0.1 is being used, then

$${C}_{1} = {ElGamalEnc}_{{S}_{i}} ( h ( D ) ) , and thus ElGamalResolve ( {ElGamalPartialDec}_{{x}_{1} \cdot {x}_{2} \cdot … \cdot {x}_{k}} ( {C}_{1} ) ) = h ( D ) , therefore ψ = {g}^{( h ( D ) {α}_{1} \cdot {α}_{2} \cdot … \cdot {α}_{k} )} = P ( D ) .$$

If, on the other hand, the pseudonymisation function has been defined according to the equation 2.0.2, then C₁=(Eᵢ)^{h(D)}, and therefore according to the equivalence 3.3

$$ElGamalResolve ( {ElGamalPartialDec}_{{x}_{1} \cdot {x}_{2} \cdot … \cdot {x}_{k}} ( {C}_{1} ) ) = {( {b}_{1} \cdot {b}_{2} \cdot \cdot {b}_{k} )}^{h ( D )} , thus ψ = {g}^{( {( {b}_{1} \cdot {b}_{2} \cdot … \cdot {b}_{k} )}^{h ( D ) \cdot {α}_{1} \cdot {α}_{2} \cdot … \cdot {α}_{k}} )} = P ( D ) .$$

It therefore holds true that in both cases ψ=P(D).

### Additional Information on Attribute Encryption

In the previous sections only the process of calculating the pseudonyms was described. In itself, this opens up few possibilities for data analysis. A preferred application of the present pseudonymisation method is that (with due care). various other data (entity attributes) can also be attached to the entity identifiers, these data accompanying the entity identifiers during the steps of the pseudonymisation process.

Preferably, in this case the entity attributes are also subjected to an encryption process, namely such that the entity attribute leaves the data source already in the form of a cipher, and this cipher is overwritten by the mappers in each step by a different respective cipher that, although different in each step, mathematically still carries the same message. This solution provides that an attacker (e.g., a data source with malicious intent) is not able to utilize the entity attributes for assigning the entity identifier, thereby cracking the anonymity provided by the method.

### Entity Attribute Encryption Process

The attribute encryption step added to the submission step is as follows:
4.1.1 The entity attribute A corresponding to the entity identifier D is encrypted by the data source DSᵢ in the following manner:

$${A}_{1 , 1} = {ElGamalEncrypt}_{{S}_{i}} ( A )$$

4.1.2 After that, in addition to the cipher C₁, the data source DSᵢ also sends the cipher A_{1,1} in a message sent to the mapper M_{π}_{₁}.

The attribute encryption step added to the rerandomization step is the following:

The following operations must be performed for each index j=1, 2, . . . , k:
4.2.1 After receiving the cipher A_{1,j} attached to the cipher Cⱼ, the mapper M_{π}_{ⱼ} checks if both components thereof are elements of the set H, and, if the result of the check is positive, it calculates the cipher A_{1,j+1} in the following manner:

$${A}_{1 , j + 1} = {ElGamalRerandomize}_{{R}_{{π}_{j}}} ( {A}_{1 , j} )$$

4.2.2 If j<k, then, in addition to the cipher Cⱼ₊₁, the mapper M_{π}_{ⱼ} also sends the cipher A_{1,j+1} in a message sent to the mapper M_{π}_{ⱼ₊₁}.
4.2.3 If, in turn, j=k, then, in addition to the values Z₁, K₁, U₁, the M_{π}_{ⱼ} also sends the cipher A_{2,1}=A_{1,j+1} in a message sent to the mapper [symbol] .

The attribute encryption step added to the pseudonym decryption step is the following:

The following operations must be performed for each index j=1, 2, . . . , k:
4.3.1 After receiving the cipher A_{2,j} attached to the values Zⱼ, Kⱼ, Uⱼ, the mapper [symbol] checks if both components thereof are elements of the set H, and, if the result of the check is positive, it calculates the cipher A_{2,j+1} in the following manner:

$${A}_{2 , j + 1} = {ElGamalRerandomize}_{{R}_{{ϱ}_{j}}} ( {A}_{2 , j} )$$

4.3.2 If j<k, then the mapper [symbol] also sends the cipher A_{2,j+1} to the mapper [symbol] in a message containing the value Zⱼ₊₁, the key Kⱼ₊₁, and the cipher Uⱼ₊₁.
4.3.3 The cipher A_{2,k+1} is the final encrypted form of entity attribute A.

### Decryption Process of the Encrypted Entity Attributes

The entity attributes A can only be decrypted with the consent of all mappers.

Let μ₁, μ₂, . . . , μₖ be an arbitrary-order permutation of the numbers 1,2, . . . , k.

The entity attribute is decrypted performing the following steps:
5.1.1 The mapper M_{μ}_{₁} calculates the following value:

$${B}_{{μ}_{1}} = {ElGamalPartialDec}_{{x}_{{μ}_{1}}} ( {A}_{2 , k + 1} )$$

5.1.2 For each value j=1, 2, . . . , k the mapper μⱼ calculates the following value:

$${B}_{{μ}_{j + 1}} = {ElGamalPartialDec}_{{x}_{{μ}_{j}}} ( {B}_{{μ}_{j}} )$$

The entity attribute A is then obtained as A=ElGamalResolve(B_{μ}_{ₖ₊₁}_{).}

Note: Without knowing the private key x₁·x₂· . . . ·xₖ, the ciphers A_{1,1}, A_{1,2}, . . . , A_{1,k+1} and A_{2,1}, A_{2,2}, . . . , A_{2,k+1} are indistinguishable from integer pairs chosen independently of each other in a random manner even if the value of the attribute A is known. If the system operates correctly, the same number pair A_{2,k+1} will never be generated twice. Therefore, the entity attributes cannot be utilized for a data marking attack.

### Preferred Applications Complementing the Pseudonymisation Method

It is particularly preferable if, in the above-described system, the mappers do not process the messages in the order of their reception, but instead they apply a so-called “mix network” mentioned in the introduction. Furthermore, if, from a business aspect it is not important that the entity identifiers are mapped to the pseudonyms immediately after being submitted, an alternative version of the mix network can also be applied: the incoming messages are first put on a waiting list by all mappers, and, in each case when the size of its waiting list exceeds a certain predetermined limit (e.g. 100 messages), the mapper randomly chooses a message from the list, and, after forwarding it, it waits until the size of the list again exceeds the preset limit. This ensures that a relationship between the identifiers and the pseudonyms cannot be established even from the generation order of the pseudonyms. The greater the limit regarding the length of the waiting list, the more effective the temporal mixing of the messages, but also the more the mapping process is hindered. Therefore, it is expedient to choose such a limit value that balances these two effects.

There is a large number of options for choosing the type of the group G; two of these will be scrutinised below. One of the opportunities is that G is a so-called Schnorr group (see e.g., the corresponding Wikipedia article). This option makes the ElGamal encryption defined over the multiplicative group mod p more secure. According to the other suggested option, G is a group defined by a prime-order elliptic curve defined over a finite field (see the Wikipedia article “Elliptic-curve cryptography”). In this case, the exponentiation operation over G is defined as the multiplication by a scalar of the elliptic point (i.e., the repeated addition of the elliptic point). It is important that the order of the group G is high enough (i.e., an order ensuring that the key size of ElGamal encryption over the multiplicative group mod φ is secure).

The are multiple options for the exact selection of the group G. It is not recommended to choose a predetermined, known group, because, according to recent research, certain “preprocessing” attacks may offer significant help in cracking one of the cryptographic problems forming the basis of the present invention, namely the sqDDH problem (see the article by Henry Corrigan-Gibbs and Dmitry Kogan entitled “The Discrete-Logarithm Problem with Preprocessing”, DOI: 10.1007/978-3-319-78375-8_14).

The algebraic group G and the generator element g are preferably predetermined by the entity or entities responsible for the implementation or the operation of the system. Optionally, they can also be predetermined in a decentralised manner by the mappers, expediently according to some type of commitment scheme (see e.g., the Wikipedia article “Commitment scheme”). This, for example, can be performed by applying such a deterministic pseudorandom number generator for generating the group G that has the number N₁⊗N₂⊗ . . . ⊗Nₖ as its seed (starting value), where for each index j the integer Nⱼ is selected randomly from a sufficiently large interval by the mapper Mⱼ, and the symbol ⊗ denotes a bitwise XOR operation. Each mapper reveals its own Nⱼ value only after publishing a value F(Nⱼ) (“commitment”) calculated therefrom by a predetermined cryptographic hash function F, and after ensuring that every other mapper has also done so. Thereafter, based on the commitment values, each mapper is able to make sure that there has been no such manipulation which could affect the random nature of the value N₁⊗N₂⊗ . . . ⊗Nₖ.

It is strongly recommended to choose the set H such that it forms a Schnorr group with regard to modulo φ multiplication. Otherwise, a maliciously acting mapper could choose a small integer (e.g., on the order of a million) x that is a submultiple of φ, and participate in the process utilizing the value

$${α}_{j} = \frac{φ}{x} .$$

Thereby, the range of the pseudonymisation function P could be significantly reduced (in both the first and second alternatives), to the extent that the malicious actor could even reproduce the function P applying a brute force attack, and then use it for cracking pseudonyms. Such an attack cannot be executed in case the set H is a Schnorr group, because in that case φ is a prime, so there does not exist a suitable x value (the attacker cannot succeed either in case it chooses x=1 or x=φ). It can be relatively easily provided that both the set H and the group G form a Schnorr group; a possible exemplary implementation is the following:
1. A prime number q is chosen randomly (preferably according to a uniform distribution, for example applying the Miller-Rabin prime test), of which prime number the binary representation consists of B bits.
2. Such an integer r is searched for between 2 and B for which it holds true that p=r·q+1 is prime (for example it is checked applying the Miller-Rabin prime test). If there is no such number r, we return to step 1.
3. Such an integer s is searched for between 2 and B for which it holds true that N=s·p+1 is prime. If there is no such number s, we return to step 1.
4. Integer numbers are randomly chosen (preferably according to a uniform distribution) between 2 and (p−1) until such a number f is found that f is relatively prime to p, and f^{s}≢1 mod N.
5. The generator element g is defined by the value f^{s} mod N, the group G being defined as a group of reduced residue classes a over modulo N for which it holds true that a^{s}≢1 mod N and a^{p}≡1 mod N.
6. The set H is defined as a set of integers a between 1 and p that are relatively prime to p, while a^{r}≢1 mod P and a^{q}≡1 mod p.

In this case, random selection from the set H can be implemented easily, e.g., by applying the Monte Carlo method (see the Wikipedia article “Monte Carlo method”).

Data sources may optionally also fulfil a mapping role. This further improves the security of the system, as it ensures that the other mappers cannot generate the open entity identifier even if all of them maliciously collude.

Optionally, multiple entity attributes can even be submitted simultaneously, attached to the same entity identifier. In that case, the entity attributes must be encrypted parallelly with each other and with the entity identifier. It must be made sure that an attacker is not able to perform data marking by submitting an unusually large number of entity attributes simultaneously with an entity identifier. It is recommended to restrict the number of entity attributes that can be submitted simultaneously.

As a special case, in the above-described process the case A=D may also occur; in other words, the submitted entity attribute may be identical to the entity identifier. This can be useful in case the field of application requires that the entity identifiers are decrypted from time to time, for example in the case of providing fraud prevention and fraud discovery services, because the pseudonymisation process is not reversible (not even by the consent of all mappers).

### A Typical, Exemplary Application and Implementation

In the following, a possible mode of application of the invention will be described. One of the unsolved problems related to the operation of commercial plasma collectors is that the companies are unable to credibly establish that a given donor has not exceeded the maximum allowed number of plasma donations (in Hungary, this number is 45). This is because a donor may apply at two different companies and donate plasma 40 times at each company. This fraud can be discovered only if the plasma companies share data between them. However, sharing the donors' personal data is ethically reprehensible (and is also against the law).

The present invention can be applied for discovering this kind of fraud in the following manner:
the data sources DSᵢ are the plasma companies participating in the fraud discovery program,
the entity identifiers D are the social security numbers of the donors registered with the participating plasma companies,
the entity attributes A are also the social security numbers of the donors registered with the participating plasma companies,
the mappers Mⱼ are entities that cooperate with or are independent from the participating plasma companies (each plasma company may operate an own mapper Mⱼ if it desires so, thereby ensuring that the entity identifiers D submitted by it cannot be decrypted even in the case of the malicious collusion of all the other plasma companies),
applying the above-described method, the mappers Mⱼ calculate the pseudonyms P and the encrypted entity attributes A_{2,k+1} corresponding thereto,
if a pseudonym P has more occurrences in the database containing pseudonymised data than what is allowed (e.g. >45), the encrypted entity attribute A_{2,k+1} is decrypted by the mappers Mⱼ by mutual agreement, thereby obtaining the entity identifier D of the fraudulent donor.

### CONCLUSION

Therefore, the following data conversion is performed by the invention in order to ensure that even a collusion between all of the data sources and all but one of the mappers is not sufficient to allow for deciphering the relationship between the pseudonym P(D) and the entity identifier D:
from data that are available at data sources DSᵢ and that are suitable for identifying persons, things, or other entities by a characteristic name, i.e., from the entity identifier D,
such pseudonymised data are produced in which each entity identifier D is replaced by a respective pseudonym P assigned thereto in a one-to-one manner (independent of the value of the cryptographic keys utilized by the data source DSᵢ),
   such that
the data sources DSᵢ generate the cipher C₁ from the entity identifiers D in their possession,
these ciphers are mapped into respective pseudonyms by a plurality of encryption means called mappers Mⱼ, the mapping being performed by the mappers Mⱼ in a centralized system or in a decentralized (peer-to-peer, e.g., blockchain) network applying their respective own unique cryptographic keys bⱼ or mapping cryptographic keys αⱼ executing their own operation in an arbitrary order,
   such that
the mappers calculate from each cipher the value

$$P ( D ) = {g}^{( {h ( D )}^{{α}_{1} \cdot {α}_{2} \cdot ... \cdot {α}_{k}} mod φ )}$$

or the value

$$P ( D ) = {g}^{( {( {b}_{1} \cdot {b}_{2} \cdot ... \cdot {b}_{k} )}^{h ( D ) \cdot {α}_{1} \cdot {α}_{2} \cdot ... \cdot {α}_{k}} mod φ )}$$

in a secure manner, where g is the generator element of the group G utilized for encryption, φ is the order (number of elements) of the group G, and h is a predetermined function (e.g. a cryptographic hash function) mapping integers to integers,
this modular exponentiation, or a deterministic function thereof (e.g., applying a cryptographic hash function) will be treated as the pseudonym of the entity.

The computer system implementing the functionalities according to the invention is adapted for generating pseudonymised data related to entities, and comprises
databases DBIᵢ containing the entity-related data that are owned by the data sources DSᵢ, wherein the data are identified applying the entity identifiers D of the entities,
a database DBP containing pseudonymised data, wherein the pseudonymised data are identified by pseudonyms P assigned to the respective entity identifiers D applying a one-to-one mapping,
more than one (a number k of) mappers Mⱼ,
optionally, a key manager KM, and
modules implementing the above-described functions and/or entities, which modules can be hardware, software, or combined hardware-software modules.

Another aspect of the invention is a computer program comprising instructions which, when the program is executed by a computer, cause the computer to carry out the steps of the method according to the invention. The invention further relates to a computer-readable medium adapted for storing the above-mentioned computer program.

The invention can also be applied for all other purposes for which the technical solution described in the document WO 2021/009528 A1 can be applied.

1. A cryptographic pseudonym mapping method for an anonymous data sharing system, the method being adapted for generating pseudonymised data from entity data originating from data sources (DSᵢ), wherein the data are identified at the data sources (DSᵢ) by entity identifiers (D) of the respective entities, and wherein the pseudonymised data are identified by pseudonyms (P) assigned to the respective entity identifiers (D) applying a one-to-one mapping,
characterised by applying, for a number n of data sources (DSᵢ)
more than one, a number k of mappers (Mⱼ),
with an algebraic group (G) having an order φ, and within that, a generator element (g) of the algebraic group (G) being predetermined with respect to the mappers (Mⱼ) and data sources (DSᵢ), and with a set (H) being also predetermined, said set (H) being a subset of integers being coprime to φ that forms an algebraic group with regard to modulo φ multiplication, furthermore, a mapping (h) assigning an integer value to each entity identifier (D) with respect to the mappers (Mⱼ) and data sources (DSᵢ) being also predetermined, and
for each index j=1, 2, . . . , k:
i. the actual mapper (Mⱼ) selecting for itself, in a random manner, an integer xⱼ and an integer αⱼ,
ii. the actual mapper (Mⱼ) selecting an integer bⱼ from the set (H) in a random manner,
for each index j=1, 2, . . . , k the actual mapper (Mⱼ) generating, cooperating with the other mappers (Mⱼ), such a first ElGamal public key (Rⱼ) that corresponds to the private key x₁·x₂· . . . ·xₖ, and storing the generated first ElGamal public key (Rⱼ) by the actual mapper (Mⱼ),
for each index i=1, 2, . . . , n the actual data source (DSᵢ) generating, in cooperation with the mappers (Mⱼ), such a second ElGamal public key (Sᵢ) that corresponds to the private key x₁·x₂· . . . ·xₖ, and storing the generated second ElGamal public key (Sᵢ) by the actual data source (DSᵢ),
and,
in the course of the pseudonymisation of an entity identifier (D) by a data source (DSᵢ), the data source (DSᵢ)
i. calculating an ElGamal cipher (C₁) applying one of the following two alternatives:
$${C}_{1} = {ElGamalEnc}_{{S}_{i}} ( h ( D ) )$$
$$or$$
$${C}_{1} = {( {E}_{i} )}^{h ( D )} ,$$
wherein, in the case of the first alternative, the range of the function h is a subset of the set (H), and in the case of the second alternative, for each index i=1, 2, . . . , n the actual data source (DSᵢ) generates, in cooperation with the mappers (Mⱼ), such an ElGamal cipher (Eᵢ) of the value b₁·b₂· . . . ·bₖ that can be decrypted utilizing the ElGamal private key x₁·x₂· . . . ·xₖ:
$$ElGamalResolve ( {ElGamalPartialDec}_{{x}_{1} \cdot {x}_{2} \cdot ... \cdot {x}_{k}} ( {E}_{i} ) ) ≡ {b}_{1} \cdot {b}_{2} \cdot ... \cdot {b}_{k} mod φ$$
ii. selecting a number π₁ from the numbers 1, 2, . . . , k in a random manner, and
iii. sending the ElGamal cipher (C₁) to the mapper (M_{π}_{₁}) that corresponds to the number π₁,
for each ElGamal cipher (C₁) received in the system, the mappers (Mⱼ) carrying out the following operations for each index j=1, 2, . . . , k in the following order:
i. the actual mapper (M_{π}_{ⱼ}) checks if both components of the ElGamal cipher Cⱼ are elements of the set (H), and continues the process only in case the result of the check is positive,
ii. the actual mapper (M_{π}_{ⱼ}) calculates the subsequent ElGamal cipher (Cⱼ₊₁):
$${C}_{j + 1} = {ElGamalRerand}_{{R}_{{π}_{j}}} ( {( {C}_{j} )}^{{α}_{{π}_{j}}} ) ,$$
iii. if j<k, then the actual mapper (M_{π}_{ⱼ}) randomly selects from the numbers 1, 2, . . . , k such a number πⱼ₊₁ that is not among the numbers π₁, π₂, . . . , πⱼ, and then sends in a message the subsequent ElGamal cipher (Cⱼ₊₁) to the mapper (M_{π}_{ⱼ₊₁}) corresponding to the number πⱼ₊₁,
iv. if j=k, then the actual mapper (M_{π}_{ⱼ}) randomly chooses a number [symbol] ₁ from the numbers 1, 2, . . . , k, and sends in a message to the mapper ( [symbol] ) corresponding to the number [symbol] ₁ the following information:
$${Z}_{1} = g$$
$${K}_{1} = {R}_{{π}_{k}}$$
$${U}_{1} = {C}_{k + 1}$$
thereafter the mappers ( [symbol] ) carrying out, for each index j=1, 2, . . . , k, in this order, the following operations:
i. the actual mapper ( [symbol] ) checks if both components of the ElGamal cipher Uⱼ are elements of the set (H), and continues the process only in case the result of the check is positive,
ii. the actual mapper ( [symbol] ) checks if both components of the ElGamal public key Kⱼ are elements of the set (H), and continues the process only in case the result of the check is positive,
iii. the actual mapper ( [symbol] ) randomly chooses an integer from the set (H) and determines an integer fⱼ such that: eⱼ·fⱼ≡1 mod φ
iv. the actual mapper ( [symbol] ) calculates the followings:
$$a value ( {Z}_{j + 1} ) : {Z}_{j + 1} = {( {Z}_{j} )}^{{e}_{j}} ,$$
$$a key ( {K}_{j + 1} ) : {K}_{j + 1} = ElGamalKeyRerand ( {K}_{j} ⊖ {x}_{{ϱ}_{j}} ) , and$$
$$a cipher ( {U}_{j + 1} ) : {U}_{j + 1} = {ElGamalRerand}_{{K}_{j + 1}} ( {ElGamalPartialDec}_{{x}_{{ϱ}_{j}}} ( {U}_{j} ) \cdot {f}_{j} ) ,$$
v. if j<k, then the actual mapper ( [symbol] ) randomly chooses from the numbers 1, 2, . . . , k such a number [symbol] ⱼ₊₁ that is not among the numbers [symbol] ₁, [symbol] ₂, . . . , [symbol] ⱼ, and then sends in a message to the mapper ( [symbol] ) corresponding to the chosen number [symbol] ⱼ₊₁ the value (Zⱼ₊₁), the key (Kⱼ₊₁) and the cipher (Uⱼ₊₁) generated in the previous step,
vi. and, if j=k, then the actual mapper ( [symbol] ) generates the pseudonym (P) corresponding to the entity identifier (D):
$$P = {( {Z}_{k + 1} )}^{ElGamalResolve ( {U}_{j + 1} )}$$

2. The method according to claim 1, characterised in that, in the course of generating the first ElGamal public keys (Rⱼ),
for each index j=1, 2, . . . , k:
vii. the actual mapper (Mⱼ) randomly chooses an integer rⱼ from the set (H),
viii. the actual mapper (Mⱼ) randomly chooses an integer number tⱼ,
ix. utilizing the chosen number tⱼ, the actual mapper (Mⱼ) generates an ElGamal public key (K_{j,1}) corresponding thereto: K_{j,1}=(rⱼ, (rⱼ)^{t}^{ⱼ} mod φ),
x. if j>1, then the actual mapper (Mⱼ) sends to the first mapper (M₁) the ElGamal public key (K_{j,1}) corresponding to the chosen number tⱼ,
xi. for each index τ=1, 2, . . . , k, in this order, the actual mapper (M_{τ}) checks if both components of the actual ElGamal public key (K_{j,τ}) are elements of the set (H), and, if the result of the check is positive, it calculates therefrom the subsequent ElGamal public key (K_{j,τ+1}): K_{j,τ+1}=ElGamalKeyRerand(K_{j,τ}⊗x_{τ}), and if τ<k, sends it to the subsequent mapper (M_{τ+1}),
xii. the last mapper (Mₖ) sends to the actual mapper (Mⱼ) the subsequent ElGamal public key (K_{j,k+1}), and
xiii. the actual mapper (Mⱼ) generates and stores the first ElGamal public key (Rⱼ):
$${R}_{j} = {K}_{j , k + 1} ⊖ {t}_{j} .$$

3. The method according to claim 1, characterised in that, in the course of generating the second ElGamal public keys (Sᵢ),
for each index i=1, 2, . . . , n:
i. the actual data source (DSᵢ) randomly chooses an integer number sᵢ from the set (H),
ii. the actual data source (DSᵢ) randomly chooses an integer number uᵢ
iii. the actual data source (DSᵢ) generates the ElGamal public key (L_{i,1}) that corresponds to the chosen numbers: L_{i,1}=(sᵢ, (sᵢ)^{u}^{ᵢ} mod φ),
iv. the actual data source (DSᵢ) sends to the first mapper (M₁) the ElGamal public key (L_{i,1}) that corresponds to the chosen numbers,
v. for each index τ=1, 2, . . . , k, in this order, the actual mapper (M_{τ}) checks if both components of the received ElGamal public key (L_{i,τ}) are elements of the set (H), and, if the result of the check is positive, it calculates the subsequent ElGamal public key (L_{i,τ+1}): L_{i,τ+1}=ElGamalKeyRerand(L_{i,τ}⊗x_{τ}), and if τ<k, sends it to the subsequent mapper (M_{τ+1}),
vi. the last mapper (Mₖ) sends to the actual data source (DSᵢ) the subsequent ElGamal public key (L_{i,k+1}), and
vii. the actual data source (DSᵢ) generates and stores the second ElGamal public key
$$( {S}_{i} ) : {S}_{i} = {L}_{i , k + 1} ⊖ {u}_{i} .$$

4. The method according to claim 1, characterised in that the ElGamal ciphers (Eᵢ) adapted for being decrypted utilizing the ElGamal private key are generated as follows:
For each index i=1, 2, . . . , n:
i. the data source (DSᵢ) randomly chooses a value γ_{i,0} from the set (H).
ii. the data source (DSᵢ) generates the cipher (γ_{i,1}) corresponding to the chosen
$$value : {γ}_{i , 1} = {ElGamalEnc}_{{S}_{i}} ( {γ}_{i , 0} ) ,$$
iii. the data source (DSᵢ) sends the cipher (γ_{i,1}) to the first mapper (M₁),
iv. for each index j=1, 2, . . . , k, in this order, the actual mapper (Mⱼ) checks if both components of the actual ElGamal cipher (γ_{i,j}) are elements of the set (H), and, if the result of the check is positive, it calculates the subsequent cipher (γ_{i,j+1}): γ_{i,j+1}=ElGamalRerand_{R}_{ⱼ}(γ_{i,j})·bⱼ, and if j<k, it sends the calculated cipher (γ_{i,j+1}) to the subsequent mapper (Mⱼ₊₁),
v. the last mapper (Mₖ) sends the calculated cipher (γ_{i,k+1}) it has received to the data source (DSᵢ), and
vi. the data source (DSᵢ) generates and stores the ElGamal cipher (Eᵢ): Eᵢ=γ_{i,k+1}·((γ_{i,0})⁻¹ mod φ).

5. The method according to claim 1, characterised in that:
for calculating the ElGamal cipher (C₁), the first alternative is applied by all data sources (DSᵢ) for each entity identifier (D): C₁=ElGamalEnc_{S}_{ᵢ}(h(D)), where the range of the function h is a subset of the set (H),
or
for calculating the ElGamal cipher (C₁), the second alternative is applied by all data sources (DSᵢ) for each entity identifier (D): C₁=(Eᵢ)^{h(D)}.

6. The method according to claim 1, characterised in that the random selections are performed according to a uniform distribution.

7. The method according to claim 1, characterised in that the mapping (h) adapted for assigning an integer value to each entity identifier (D) is a cryptographic hash function that is defined over the space of entity identifiers (D) and maps to an interval [0, φ].

8. The method according to claim 1, characterised in that the algebraic group (G) is a Schnorr group.

9. The method according to claim 1, characterised in that the algebraic group (G) is a prime-order elliptic curve defined over a finite field.

10. The method according to claim 1, characterised in that the set (H) forms a Schnorr group with regard to modulo φ multiplication.

11. The method according to claim 1, characterised in that the data sources (DSᵢ) share the ElGamal ciphers (C₁) with the mappers (Mⱼ) by writing them into a database that operates according to a protocol verified by third parties and provides decentralized authenticity.

12. The method according to claim 11, characterised in that a blockchain database is applied as the database providing decentralized authenticity.

13. The method according to claim 1, characterised in that the mappers (Mⱼ) constitute a decentralized network and communicate with each other over encrypted channels.

14. The method according to claim 13, characterised in that the mappers (Mⱼ) do not immediately send the messages containing the ElGamal ciphers (Cⱼ₊₁), values (Zⱼ₊₁), keys (Kⱼ₊₁), and ciphers (Uⱼ₊₁) generated by them to the respective subsequent mapper, but instead put them on a waiting list, and, when the size of the waiting list has exceeded a predetermined limit, they send the messages in a random order.

15. The method according to claim 13, characterised in that the mappers (Mⱼ) do not immediately send the messages containing the ElGamal ciphers (Cⱼ₊₁), values (Zⱼ₊₁), keys (Kⱼ₊₁) and ciphers (Uⱼ₊₁) generated by them to the respective subsequent mapper, but instead send these messages after a randomly chosen time period has elapsed.

16. The method according to claim 13, characterised in that the mappers (Mⱼ) do not immediately process the received messages containing ElGamal ciphers (Cⱼ₊₁), values (Zⱼ₊₁), keys (Kⱼ₊₁), and ciphers (Uⱼ₊₁), but instead put them on a waiting list and, after the size of the waiting list has exceeded a predetermined limit, they randomly choose a message from among the received messages and perform the subsequent mapping step on it.

17. The method according to claim 13, characterised in that the mappers (Mⱼ) do not immediately process the received messages containing ElGamal ciphers (Cⱼ₊₁), values (Zⱼ₊₁), keys (Kⱼ₊₁), and ciphers (Uⱼ₊₁), but instead they carry out on each message to the subsequent mapping step after a respective randomly chosen time period has elapsed.

18. The method according to claim 1, characterised in that each ElGamal cipher (Cⱼ₊₁), value (Zⱼ₊₁), key (Kⱼ₊₁), and cipher (Uⱼ₊₁) is shared by writing into a database providing decentralized authenticity.

19. The method according to claim 18, characterised in that a blockchain database is applied as the database providing decentralized authenticity.

20. The method according to claim 1, characterised in that the algebraic group (G), the generator element (g), and the set (H) are predetermined by the entity or entities responsible for the implementation or the operation of the system.

21. The method according to claim 1, characterised in that the algebraic group (G), the generator element (g), and the set (H) are predetermined by the mappers (Mⱼ) in a decentralized manner.

22. The method according to claim 1, characterised in that the algebraic group (G), the generator element (g), and the set (H) are predetermined by the following algorithm:
i. choosing randomly, according to a uniform distribution, a prime number q, the binary representation of which consists of B bits,
ii. searching for an integer r between 2 and B for which it holds true that p=r·q+1 is prime; if no such r can be found, returning to step i,
iii. searching for an integer s between 2 and B for which it holds true that N=s·p+1 is prime; if no such s can be found, returning to step i,
iv. choosing randomly, according to a uniform distribution, integer numbers between 2 and (p−1) until such a number f is found that f is relatively prime to p, and f^{s}≢1 mod N,
v. defining the generator element g as the value f^{s} mod N, and defining the group G as a group of reduced residue classes a over modulo N for which it holds true that a^{s}≢1 mod N and a^{p}≡mod N,
vi. defining the set (H) as a set of integers a between 1 and p where a is relatively prime to p, a^{r}≢1 mod P, and a^{q}≡1 mod p.

23. The method according to claim 22, characterised in that a pseudorandom number generator determined in the following manner is applied in the algorithm utilized for defining the algebraic group (G), the generator element (g), and the set (H):
each mapper (Mⱼ) chooses an integer Nⱼ from a predetermined range,
each mapper (Mⱼ) publishes a commitment value F(Nⱼ), where F is a cryptographic hash function,
each mapper (Mⱼ) waits until all of the values F(Nⱼ) are published,
each mapper (Mⱼ) publishes its own Nⱼ value,
the mappers (Mⱼ) calculate the value N₁⊗N₂⊗ . . . ⊗Nₖ, where the symbol ⊗ denotes a bitwise XOR operation,
the value N₁⊗N₂⊗ . . . ⊗Nₖ is applied as the seed of the pseudorandom number generator utilized for defining the algebraic group (G), the generator element (g), and the set (H).

24. The method according to claim 1, characterised in that one or more attributes (A) belong to each entity identifier (D), which attribute/attributes is/are attached in unencrypted form to the ElGamal cipher (C₁) calculated as an encrypted entity identifier, to the value calculated in the course of pseudonym calculation, and to the calculated pseudonyms (P), followed by matching and/or collecting the attributes (A) based on the pseudonyms (P).

25. The method according to claim 1, characterised in that one or more attributes (A) belong to each entity identifier (D), which attribute/attributes is/are attached by the data source (DSᵢ) in encrypted form to the ElGamal cipher (C₁) calculated as an encrypted entity identifier,
such that
the attribute (A) corresponding to the entity identifier (D) is encrypted by the data source (DSᵢ) in the following manner:
$${A}_{1 , 1} = {ElGamalEncrypt}_{{S}_{i}} ( A )$$
then, in addition to the ElGamal cipher (C₁), the encrypted attribute (A_{1,1}) is also sent by the data source (DSᵢ) to the mapper (M_{λ}_{₁}) in a message,
for each index j=1, 2, . . . , k:
i. after receiving the encrypted attribute (A_{1,1}) attached to an ElGamal cipher (C₁), the actual mapper (M_{π}_{ⱼ}) checks if both components thereof originate from the set (H), and, if the result of the check is positive, it calculates the subsequent value (A_{1,j+1}) of the encrypted attribute in the following manner:
$${A}_{1 , j + 1} = {ElGamalRerandomize}_{{R}_{{π}_{j}}} ( {A}_{1 , j} )$$
ii. if j<k, then, in addition to the subsequent ElGamal cipher (Cⱼ₊₁), the actual mapper (M_{π}_{ⱼ}) also sends the subsequent value (A_{1,j+1}) of the encrypted attribute in a message sent to the subsequent mapper (M_{π}_{ⱼ₊₁}),
iii. if j=k, then, in addition to the values Z₁, K₁, U₁, the actual mapper (M_{π}_{ⱼ}) sends in a message sent to the mapper ( [symbol] ) corresponding to the number [symbol] ₁ a value A_{2,1}=A_{1,j+1} that is calculated as the subsequent value of the encrypted attribute and which corresponds to the first encrypted attribute value (A_{2,1}) of the subsequent order of mappers, and then
for each index j=1, 2, . . . , k:
i. if both components of the encrypted attribute value (A_{2,j}) are elements of the set (H), then the actual mapper ( [symbol] ) calculates therefrom the subsequent value of the encrypted attribute (A_{2,j+1}) in the following manner:
$${A}_{2 , j + 1} = {ElGamalRerandomize}_{{R}_{{ϱ}_{j}}} ( {A}_{2 , j} )$$
ii. if j<k, then the actual mapper ( [symbol] ) also sends the subsequent value (A_{2,j+1}) of the encrypted attribute to the subsequent mapper ( [symbol] ) in a message containing the value (Zⱼ₊₁), key (Kⱼ₊₁), and cipher (Uⱼ₊₁),
iii. the final encrypted form (A_{2,k+1}) of the entity attribute is finally obtained.

26. A computer system implementing the method according to claim 1, the system comprising
data sources (DSᵢ) containing data related to entities,
more than one, a number k of mappers (Mⱼ),
a module adapted for generating the cryptographic keys of the data sources,
a module adapted for storing the cryptographic keys of the data sources,
a module adapted for generating the cryptographic keys of the mappers,
a module adapted for storing the cryptographic keys of the mappers,
a module adapted for encrypting the entity identifiers (D), and
a module adapted for mapping the encrypted entity identifiers (C₁) to the pseudonyms (P).

27. The computer system according to claim 26, characterised by further comprising
databases (DBIᵢ) stored at the data sources (DSᵢ), in which the data are identified applying the entity identifiers (D) of the entities, and
a database (DBP) containing pseudonymised data, in which the pseudonymised data are identified by pseudonyms (P) assigned to the respective entity identifiers (D) applying a one-to-one mapping,

28. The computer system according to claim 26, characterised by the system further comprising
data streams (SIᵢ) broadcast by the data sources (DSᵢ), wherein the data are identified by the entity identifiers (D) of the entities, and
a data stream (SP) containing pseudonymised data, wherein the pseudonymised data are identified by pseudonyms (P) assigned to the respective entity identifiers (D) applying a one-to-one mapping.

29. The computer system according to claim 26, characterised by further comprising
a key manager adapted for storing and/or generating the cryptographic keys of the data sources (DSᵢ), and
a key manager adapted for storing and/or generating the cryptographic keys of the mappers (Mⱼ).

30. A computer program comprising instructions which, when the program is executed by a computer, cause the computer to carry out the steps of any of the methods according to claim 1.

31. A computer-readable medium adapted for storing the computer program according to claim 30.
